(19) United States
(12) Patent Application Publication
(10) Pub. No.: US 2010/0153163 A1
(43) Pub. Date: Jun. 17, 2010

(54) Services registry and method for enabling determination of the quality of a service therein

(76) Inventors: Christopher Peltz, Windsor, CO (US); Radek Pospisil, Neratovice (CZ)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/314,656

(22) Filed: Dec. 15, 2008

(51) Int. Cl. G06Q 10/00; G06Q 99/00

(52) U.S. Cl. 705/9; 705/7; 705/347

(57) ABSTRACT

A services registry and method for enabling determination of the quality of a service provided therein are presented. The registry includes a service-oriented architecture (SOA) repository that takes as input information from a plurality of data sources that map to a plurality of rating dimensions. The registry further includes a rating calculation engine that receives service characteristics for a service and calculates, based on category weightings and rating rules that are customizable by an organization, a service quality rating for provision to service consumers that takes into account the plurality of rating dimensions. The rating calculation engine recalculates the service quality rating over time as the service is being used and goes through lifecycle stages.

### BACKGROUND

The Service Oriented Architecture (SOA) is an approach to information technology (IT) infrastructure design that provides methods for systems development and integration where systems group functionality around business processes and package these as interoperable services. A SOA infrastructure also allows different applications to exchange data with one another as the applications participate in business processes. Service-orientation aims at a loose coupling of services with operating systems, programming languages, and other technologies that underlie applications. SOA separates functions into distinct units, or services, http://en.wikipedia.org/wiki/Service-oriented_architecture—cite_note-Bell-1#cite_note-Bell-1, which developers make accessible over a network in order that a user can combine and reuse them in the production of business applications. These services communicate with each other by passing data from one service to another, or by coordinating an activity between two or more services.

### BRIEF DESCRIPTION OF THE DRAWINGS

Exemplary embodiments of a system and method for determining the quality of a service provided in a services registry will be described in detail with reference to the following figures, in which like numerals refer to like elements, and wherein:

FIG. 1 illustrates an exemplary system for determining the quality of a service provided in a services registry;

FIG. 2 illustrates an exemplary chart showing exemplary rating dimensions of FIG. 1;

FIG. 3 is a flow chart illustrating an exemplary method for determining the quality of the service provided in the services registry; and

FIG. 4 illustrates exemplary hardware components of a computer that may be used in connection with the method for determining the quality of the service provided in the services registry.

### DETAILED DESCRIPTION

An exemplary system and method are presented for determining the quality of a service catalogued within a services registry. The system and method provide a rating and scoring mechanism, which provides a set of characteristics that can be used by a consumer of the service concerned, i.e., a service consumer, to determine an overall rating. The embodiments described go beyond a simple weighted scoring technique and provide a set of axes and the associated scales as a weighting technique to specifically measure the quality rating of services as defined in a service-oriented architecture (SOA) architecture. Specifically, an embodiment of a configurable user rating system will be described that incorporates multiple sources of quality, including user ratings, testing results, operating monitoring quality, contract management, and the like. As a result, confidence is created for a service consumer of a service by helping them to understand the quality of the services being consumed.

Time-based metrics, e.g., a certain percentage increase or decrease in a parameter over time are also supported. Examples may be that defect rates are still low, test coverage is increasing, etc. How this changes in a temporal sense may impact overall actual/perceived service quality rating.

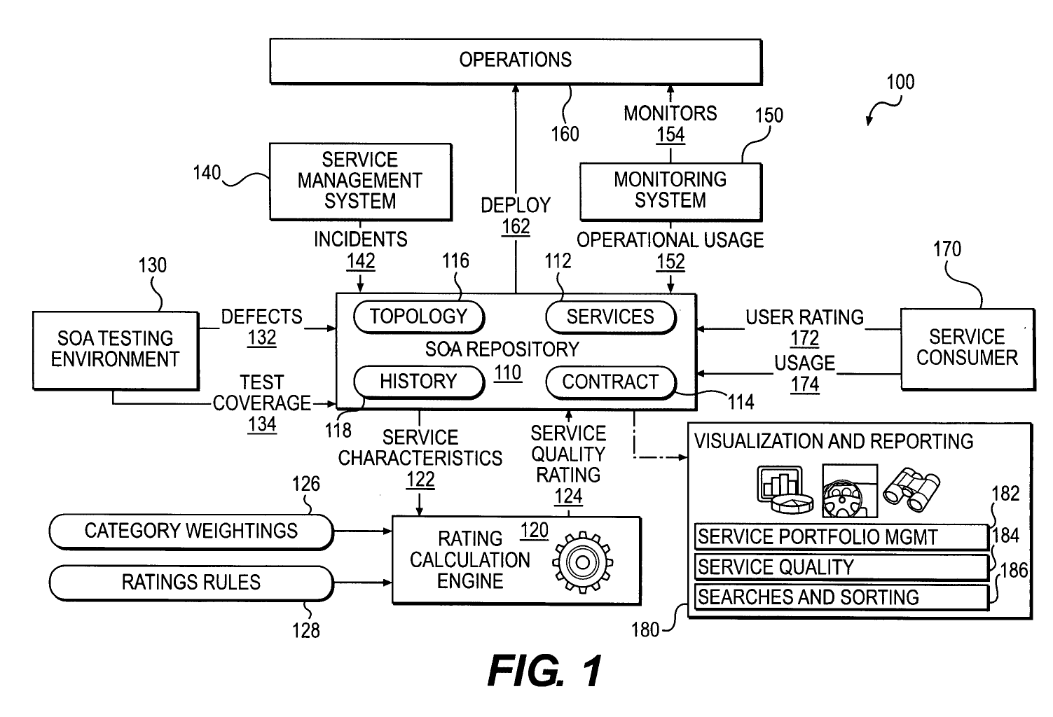

FIG. 1 illustrates an exemplary system 100 for effectively determining the quality of a service 112 provided in a services registry. The system 100 includes an SOA repository 110 that takes as inputs information from multiple sources, such as an SOA testing environment 130, a service management system 140, and an operational monitoring environment (not shown). The operational monitoring environment may include information technology (IT) operations 160 and a monitoring system 150 that monitors 154 the operations 160. The multiple sources provide input data for certain rating dimensions, i.e., dimensions to the SOA repository 110. The SOA repository 110 may include, for example, services 112, contracts 114 between a service consumer and a provider, information on topology 116 regarding how services relate to one another, and information on history 118 that keeps tracks over time how the services are being used and how the services change over time.

The SOA testing environment 130 may provide a defects rating dimension 132, and a test coverage rating dimension 134 to the SOA repository 110. The defects 132 may include, for example, bugs and issues. The SOA testing environment 130 tracks the defects 132, which each may have a set of properties, such as priority, severity, time-to-solve, developer or customer defect, and the like. The SOA testing environment 130 may provide an aggregation report related to the service 112 based on these properties. The service quality rating 124 from the defects perspective may be computed using aggregation techniques (e.g., low number of defects and lower severity and priority are better). The HP SOA Systinet software available from Hewlett-Packard Company is an exemplary product that integrates with defect management systems to trace defects and incidents 132 of a service.

The test coverage rating dimension 134 may be the number of tests and coverage percentage, such as 80% coverage of a service during testing. The service quality rating 124 from the test perspective can be higher with higher number of tests, i.e. greater test coverage. The HP SOA Systinet software available from Hewlett-Packard Company is an exemplary product that integrates with the SOA testing environment 130 that maintains and manages tests and their results.

The service management system 140 may provide insight into the number of incidents raised against a service. This incident frequency can be expressed as the incidents rating dimension 142 and provided to the SOA repository 110. The incidents 142 may be help desk issues that occur when the service 112 is being deployed 162, for example.

The monitoring system 150 monitors 154 the operations 160 to provide an operational usage rating dimension 152, i.e., operational usage, to the SOA repository 110. The formula to compute the quality of the operational usage 152 may be user-defined based on runtime properties. For example, a runtime property may include the percentage uptime (e.g., 99.99%) where quality is measured on a 0 (0%) to 1 (100%) scale. Alternatively, a runtime property may include the average response time for the service, where the quality is computed based on the variance of the runtime response time versus an agreed-upon Service Level Agreement (SLA).

The service consumer 170 may provide a user rating rating dimension 172, user rating, and a usage rating dimension 174, i.e., usage to the SOA repository 110. The usage rating can be as simple as a 1-5 rating scale. Alternatively, the usage rating can be a more complex multi-criteria rating where service consumers score a service across multiple dimensions, such as reliability, availability, and response time. Each service consumer 170 of the SOA repository 110 may express their own perception of the service quality (e.g., based on their own experience, behind-the-scenes knowledge, and the like). The service quality rating 124 from the user rating perspective may be computed as an average (or minimum or maximum) of all service consumers' ratings combined with the service consumers' credibility.

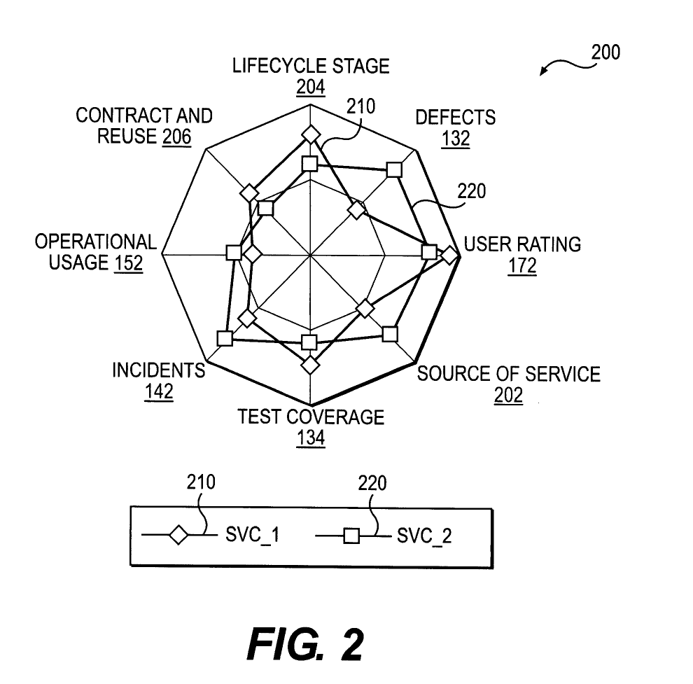

Additional exemplary rating dimensions are shown in FIG. 2 and include a contract and reuse rating dimension 206, a lifecycle stage rating dimension 204, and a source of service rating dimension 202.

Regarding the contact and reuse dimension 206, a contract management system may capture service reuse based on a service level agreement (SLA). The service quality rating 124 from the contract and reuse perspective may be computed from the number of contracts (i.e., higher number of contracts may be better) and SLA properties (e.g., availability, response time, and the like). The overall quality of the service 112 may affect the quality received by the service consumer that is in the contract 114 recursively. A service consumer may further correlate and/or combine the SLA information with the operational usage rating dimension 152 and the user rating dimension 174.

The lifecycle stage 204 may be based on a web services policy (WS-Policy) (e.g., a policy need to be fulfilled) and an approval policy (e.g., configurable number of approvers need to approve a stage change). Each lifecycle stage may have a different quality rating defined by its purpose (e.g., the development stage has lower quality rating comparing to the production stage). The service quality rating 124 from the lifecycle perspective may be computed from the quality of the current lifecycle stage (which may be configurable). Additionally, other properties, such as age of service in the lifecycle stage 204 and the number of approvers may be taken into account. For example, the lifecycle used in the HP SOA Systinet software is composed of configurable lifecycle stage 204.

Regarding the source of service dimension 202, the service 112 may be added to the SOA repository 110 from different sources. For example, the service 112 may be imported from other systems (e.g., universal description, discovery and integration (UDDI), application management systems, such as HP Business Availability Center (BAC), and the like). Alternatively, the service 112 may go through the whole lifecycle in the SOA repository 110 (i.e., development (Dev), quality assurance (QA), staging, production, and the like). The service consumer 170 typically may be able to place more trust in imported services 112 because the imported services 112 may need to be trusted already as a prerequisite to their import.

Eight exemplary rating dimensions are described above for illustration purposes. One skilled in the art will appreciate that other types of rating dimensions can be equally applied.

Referring back to FIG. 1, the system 100 further includes a rating calculation engine 120 that receives a set of service characteristics 122 for the service 112 in the SOA repository 110. Each service characteristic 122 may correspond to one or more of the rating dimensions to be measured and aggregated. An organization may determine how the aggregate rating should be calculated. An administrator may configure the SOA repository 110, i.e., entering the rating configuration as defined by the organization. Based on category weightings 126 and rating rules 128 that are customizable by the organization, the rating calculation engine 120 calculates a service quality rating 124. The organization may give weightings using priorities (e.g., high/medium/low). Alternatively, the organization may have a mechanism to allocate a certain number of points (e.g., 100) across multiple dimensions (e.g., dimension1 gets 25 points, dimension2 gets 40 points, and so on). The rating rules 128 then state how an administrator can translate the data received from the data sources to raw quality values (e.g., if defects<10 then rating=1; if defects<25 then rating=0.7, and so on). Given the rating rules 128 and the calculated raw rating scores, the administrator can then apply the weightings to get the total service quality rating across all dimensions. The service quality rating 124 may be dynamic and maintained over time because the service consumer 170 may use the service as the service moves through its typical lifecycle, including operational usage 152. Such maintenance may include monitoring of service availability and degradation over time or during certain seasonal time periods.

The system 100 may also include visualization and reporting 180 that includes elements, such as service portfolio management 182, service quality 184, and searches and sorting 186.

FIG. 2 illustrates an exemplary chart 200 showing the exemplary rating dimensions. The chart 200 defines a scale of axes, e.g., on a real number scale from 0 (lowest quality) to 1 (highest quality). Then, a specific and customizable formula may be used to compute the service quality rating 124 for each axis, along with the aggregated score using a weighted scoring technique. For example, a spider diagram may be used to visually compare the service quality rating 124 of two or more services along these exemplary eight dimensions. Such visualization techniques can help the service consumer easily compare and select the most appropriate service to use based on the ratings and the service consumer's prioritization of those ratings (as set by the weightings).

As shown in FIG. 2, service 1 (SVC_1) 210 has a high user rating 172 score, a high test coverage 134 score, and a high lifecycle stage 204 score, but a low operational usage 152 score and a low defects 132 score. Compared with service 1 (SVC_1) 210, service 2 (SVC_2) 220 has a higher defects 132 score and a higher incidents 142 score, but a slightly lower lifecycle stage 204 score and a slightly lower user rating 172 score. If the service consumer 170 considers defects and incidents scores as more important, the service consumer 170 may choose service 2 (SVC_2) 220. Based on the service consumer's review of the visualizations, the service consumer 170 may decide to re-adjust the weightings and/or the rating rules 128 and regenerate or redisplay the service rating reports.

Table 1 shown below summarizes an exemplary technique for calculating the 0.1 scales for each of the exemplary dimensions outlined above.

| Lifecycle | Each stage has a quality value as part of an administrator |
|---|---|
| Stage | configuration step. |
| Defects | A defect typically has properties of |
| | 1. (s)everity (minor/normal/major) |
| | 2. (o)rigin (customer/developer), |
| | 3. (t)ime-to-resolve |
| | 4. (q)uality of resolvent. |
| | Each of these properties may be rated in the interval |
| | {0, 1} and the aggregated calculated through |
| | multiplication (f = s * o * t * q). |
| User Rating | Average of user ratings |
| Source of | Categories with weights, customizable by organization |
| Service | |
| Test Coverage | Formula based |
| Incidents | Formula based |
| Operational | Categories based on operational usage (e.g., 0-1000 |
| Usage | invocations is 0.5; >1000 is 1, etc). Again, customizable |
| | by organization |
| Contract and | Either a recursive or non-recursive option can be used: |
| Reuse | a) Non-Recursive - the number of contracts in the |
| | service-oriented architecture (SOA) repository and the |
| | service level objective (SLO)/service level agreement |
| | (SLA) quality is used in the formula. |
| | b) Recursive - use the quality of the service consumer |
| | (client) if the service consumer has its own quality rating. |

In addition to defining the axis of service quality and the associated scales, the system 100 provides a mechanism for quality computation. Specifically, the system 100 accounts for the fact that quality levels are not static and need to be recalculated over time as the service 112 is being used or as the service 112 goes through lifecycle stages 204. Additionally, dynamic calculation may be needed because new services may be introduced into the environment or services may be decommissioned. The service quality rating 124 may be recalculated several times per day or per week, or when the administrator manually forces a quality computation to be executed.

The system 100 improves the confidence level of potential service consumers prior to service usage. The following are a few exemplary usages that the aggregated service quality rating 124 score may also deliver to an organization.

More focused searches can be performed by the service consumer 170, for example, to find services that have a quality level above or below a certain threshold level (N). Sorting of the services 112 returned from the SOA repository 110 may be done more effectively using the service quality rating 124.

Further, reports can be easily generated to show the services 112 in the SOA repository 110 that are above or below a given quality level. Additionally, trend reports based on time may be generated for the service quality rating 124. A service quality rating score (not shown) may be calculated at an aggregate level. For example, the quality of a given information technology (IT) service portfolio may be computed. Similarly, the quality of all services (i.e., the quality of an SOA) may be computed using the system 110.

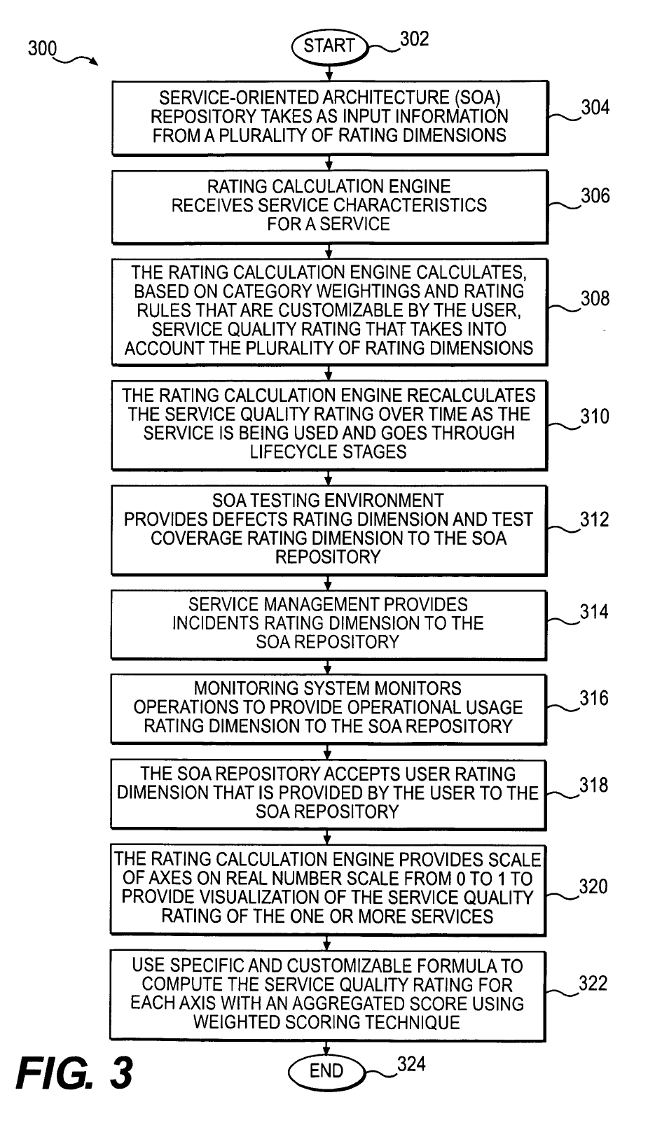

FIG. 3 is a flow chart illustrating an exemplary method 300 for effectively determining the quality of the service 112 provided in the services registry. The exemplary method 300 starts at 302. The SOA repository 110 takes as input information from a plurality of rating dimensions at block 304. The SOA repository 110 includes one or more services 112 to be offered to a service consumer 170. The rating calculation engine 120 receives service characteristics 122 for the service 112 at block 306. The rating calculation engine 120 calculates, based on the category weightings 126 and the rating rules 128 that are customizable by the organization, a service quality rating 124 for provision to service consumers that takes into account the plurality of rating dimensions (block 308). The rating calculation engine 120 recalculates the service quality rating 124 over time as the service 112 is being used and goes through lifecycle stages (block 310).

The SOA testing environment 130 provides the defects rating dimension 132 and the test coverage rating dimension 134 to the SOA repository 110 at block 312. The defects rating dimension 132 includes a set of properties including a priority, a severity, a time-to-solve, and whether a defect is a developer defect or a customer defect. A organization may, for instance, decide to place higher emphasis or importance on defects that were generated by the end customer versus those coming internally from the Quality Assurance (QA) department. The SOA testing environment 130 provides an aggregation report related to the service 112 based on the set of properties using aggregation techniques. The test coverage rating dimension 134 includes a number of tests and a coverage percentage of the service 112. The service quality rating 124 associated with the test coverage rating dimension 134 is higher with a higher number of tests.

The service management system 140 provides the incidents rating dimension 142 to the SOA repository 110 at block 314. The incidents rating dimension 142 takes into account help desk issues that occur when the service 112 is being deployed, for instance the number and/or severity of such issues.

The monitoring system 150 monitors 154 the operations 160 to provide the operational usage rating dimension 152 to the SOA repository 110 at block 316. The monitoring system 150 uses a formula that is user-defined based on runtime properties to compute the service quality rating 124 of the operational usage rating dimension 152.

The SOA repository 110 also accepts the user rating rating dimension 172 that is provided by the service consumer 170 (block 318). The user rating rating dimension 172 is based on the experience and the knowledge of the service consumer 170 on the service 112. The service quality rating 124 of the user rating rating dimension 172 is computed as an average of service ratings submitted by multiple service consumers combined with credibility ratings of the multiple service consumers.

The rating calculation engine 120 provides a scale of axes on a real number scale from 0 to 1 to provide visualization of the service quality rating 124 of the one or more services 112 (block 320). The method 300 further uses a specific and customizable formula to compute the service quality rating 124 for each axis with an aggregated score using a weighted scoring technique (block 322). The method 300 ends at 324.

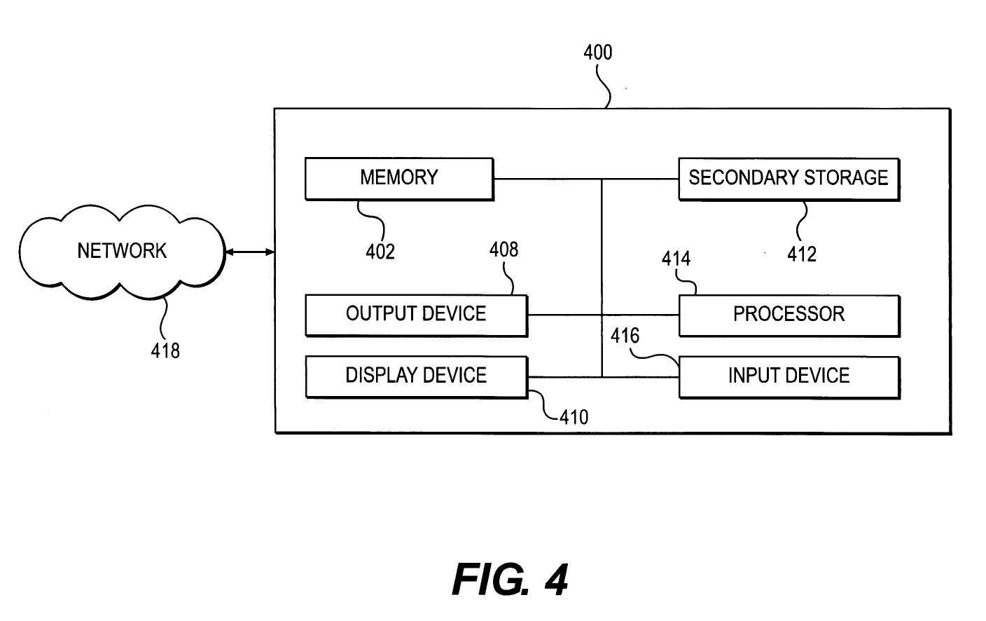

FIG. 4 illustrates exemplary hardware components of a computer 400 that may be used in connection with the method for effectively determining the quality of the service 112 provided in the services registry. The computer 400 includes a connection with a network 418 such as the Internet or other type of computer or telephone network. The computer 400 typically includes a memory 402, a secondary storage device 412, a processor 414, an input device 416, a display device 410, and an output device 408.

The memory 402 may include random access memory (RAM) or similar types of memory. The secondary storage device 412 may include a hard disk drive, floppy disk drive, CD-ROM drive, or other types of non-volatile data storage, and may correspond with various databases or other resources. The processor 414 may execute information stored in the memory 402, the secondary storage 412, or received from the Internet or other network 418. The input device 416 may include any device for entering data into the computer 400, such as a keyboard, keypad, cursor-control device, touch-screen (possibly with a stylus), or microphone. The display device 410 may include any type of device for presenting a visual image, such as, for example, a computer monitor, flat-screen display, or display panel. The output device 408 may include any type of device for presenting data in hard copy format, such as a printer, or other types of output devices including speakers or any device for providing data in audio form. The computer 400 can possibly include multiple input devices, output devices, and display devices.

Although the computer 400 is shown with various components, one skilled in the art will appreciate that the computer 400 can contain additional or different components. In addition, although aspects of an implementation consistent with the method for effectively determining the quality of a service provided in a services registry are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling the computer 400 to perform a particular method.

There has been described an embodiment of a system for determining the quality of a service provided in a services registry includes a service-oriented architecture (SOA) repository that takes as input information from a plurality of data sources that map to a plurality of rating dimensions. The SOA repository includes one or more services to be offered to a service consumer. The system further includes a rating calculation engine that receives service characteristics for a service and calculates, based on category weightings and rating rules that are customizable by an organization, a service quality rating for provision to service consumers that takes into account the plurality of rating dimensions. The rating calculation engine recalculates the service quality rating over time as the service is being used and as the service goes through application development lifecycle stages.

The plurality of rating dimensions may include a defects rating dimension, a test coverage rating dimension, an incidents rating dimension, an operational usage rating dimension, a user rating rating dimension, a contract and reuse rating dimension, a lifecycle stage rating dimension, and a source of service rating dimension.

The rating calculation engine may, in some embodiments, provide a normalized scale of axes (e.g., on a real number scale from 0 to 1) in order to provide improved insight into (e.g., visualization) of the service quality rating of the more than one service. A specific and customizable formula is used to compute the service quality rating for each axis with an aggregated score using a weighted scoring technique.

Also described has been an embodiment of a method for determining the quality of a service provided in a services registry includes providing a service-oriented architecture (SOA) repository that takes as input information from a plurality of data sources that map to a plurality of rating dimensions. The SOA repository includes one or more services to be offered to a service consumer. The method further includes providing a rating calculation engine that receives service characteristics for a service, using the rating calculation engine to calculate, based on category weightings and rating rules that are customizable by an organization, a service quality rating for provision to service consumers that takes into account the plurality of rating dimensions, and using the rating calculation engine to recalculate the service quality rating over time as the service is being used and as the service goes through lifecycle stages.

Further, an embodiment of a computer readable medium has been described that provides instructions for determining the quality of a service provided in a services registry. The instructions include providing a service-oriented architecture (SOA) repository that takes as input information from a plurality of data sources that map to a plurality of rating dimensions. The SOA repository includes one or more services to be offered to a service consumer. The instructions further include providing a rating calculation engine that receives service characteristics for a service, using the rating calculation engine to calculate, based on category weightings and rating rules that are customizable by an organization, a service quality rating for provision to service consumers that takes into account the plurality of rating dimensions, and using the rating calculation engine to recalculate the service quality rating over time as the service is being used and as the service goes through lifecycle stages.

While the system and method for effectively determining the quality of a service provided in a services registry have been described in connection with an exemplary embodiment, those skilled in the art will understand that many modifications in light of these teachings are possible, and this application is intended to cover variations thereof.

What is claimed is:

1. A services registry, comprising:
a service-oriented architecture (SOA) repository that takes as input information from a plurality of data sources that map to a plurality of rating dimensions, the SOA repository being arranged to manage metadata for one or more services to be offered to service consumers; and
a rating calculation engine that receives service characteristics for a service and calculates, based on category weightings and rating rules that are customizable by an organization, a service quality rating for provision to service consumers that takes into account the plurality of rating dimensions, wherein the rating calculation engine recalculates the service quality rating over time as the service is being used and as the service goes through lifecycle stages.

2. The registry of claim 1, wherein the SOA repository includes a contract between the service consumer and a provider, information on a topology regarding how the one or more services relate to one another and information on history that keeps track over time how the one or more services are being used and how the one or more services change over time.

3. The registry of claim 1, further comprising a SOA testing environment that provides a defects rating dimension, wherein the defects rating dimension includes a set of properties including at least one of a priority, a severity, a time-to-solve, and whether a defect is a developer defect or a customer defect, and wherein the SOA testing environment provides a report related to the service based on the set of properties using aggregation techniques.

4. The registry of claim 3, wherein the SOA testing environment provides a test coverage rating dimension to the SOA repository, the test coverage rating dimension including a number of tests and a coverage percentage of the service, wherein the service quality rating associated with the test coverage rating dimension is higher with a higher number of tests.

5. The registry of claim 1, further comprising a service management system that provides an incident frequency for an incidents rating dimension of the SOA repository, wherein the incidents rating dimension takes into account help desk issues that occur when the service is being deployed.

6. The registry of claim 1, further comprising a monitoring system that monitors operations to provide an operational usage rating dimension to the SOA repository, wherein the monitoring system uses a formula that is user-defined and based on runtime properties to compute the service quality rating of the operational usage rating dimension.

7. The registry of claim 1, wherein the plurality of rating dimensions include a user rating rating dimension that is provided by service consumers to the SOA repository and wherein the service quality rating of the user rating rating dimension is computed as an average of service ratings submitted by multiple service consumers combined with credibility ratings of the multiple service consumers and takes into account a variance of rating scores entered across a service consumer community.

8. The registry of claim 1, wherein the plurality of rating dimensions include a contract and reuse rating dimension that measures a number of contracts and a reuse frequency of the service based on a service level agreement (SLA), and wherein the service quality rating of the contract and reuse rating dimension is computed from the number of contracts, properties of the SLA, and the reuse frequency.

9. The registry of claim 1, wherein the plurality of rating dimensions include a lifecycle stage rating dimension that is based on a web services policy and an approval policy, wherein the service quality rating of the lifecycle stage rating dimension is computed from a quality rating of a current lifecycle stage, an age of the service in the current lifecycle stage, and a number of approvers needed for a stage change.

10. The registry of claim 1, wherein the plurality of rating dimensions include a source of service rating dimension, wherein a rating of the source of service rating dimension is higher when the service is imported from other systems.

11. The registry of claim 1, wherein the rating calculation engine provides a visualization of the service quality rating of the one or more services in the form of a spider diagram.

12. A method for enabling determination of the quality of a service provided in a services registry, the method being implemented on a computer including a processor and a memory a service-oriented architecture (SOA) repository stored in the memory that takes as input information from a plurality of data sources that map to a plurality of rating dimensions, the SOA repository including one or more services to be offered to a service consumer; and a rating calculation engine that receives service characteristics for a service, the rating calculation engine being executed by the processor, the method comprising;
the rating calculation engine calculating, based on category weightings and rating rules that are customizable by an organization, a service quality rating that takes into account the plurality of rating dimensions; and
the rating calculation engine recalculating the service quality rating over time as the service is being used and the service goes through lifecycle stages.

13. The method of claim 12, further comprising a SOA testing environment providing a defects rating dimension and a test coverage rating dimension to the SOA repository, wherein the defects rating dimension includes a set of properties including a priority, a severity, a time-to-solve, and whether a defect is a developer defect or a customer defect, and wherein the SOA testing environment provides an aggregation report related to the service based on the set of properties using aggregation techniques.

14. The method of claim 13, wherein the test coverage rating dimension includes a number of tests and a coverage percentage of the service, wherein the service quality rating associated with the test coverage rating dimension is higher with a higher number of tests.

15. The method of claim 12, further comprising a service management system providing a incidents rating dimension to the SOA repository, wherein the incidents rating dimension includes help desk issues that occur when the service is being deployed.

16. The method of claim 12, further comprising a monitoring system monitoring operations to provide an operational usage rating dimension to the SOA repository, wherein the monitoring system uses a formula that is user-defined based on runtime properties to compute the service quality rating of the operational usage rating dimension.

17. The method of claim 12, wherein the plurality of rating dimensions include a user rating rating dimension that is provided by a service consumer to the SOA repository and wherein the service quality rating of the user rating rating dimension is computed as an average of service ratings submitted by multiple service consumers combined with credibility ratings of the multiple service consumers.

18. The method of claim 12, further comprising the rating calculation engine providing visualization of the service quality rating of the one or more services in the form of a spider diagram.

19. The method of claim 18, further comprising using a specific and customizable formula to compute the service quality rating for each axis with an aggregated score using a weighted scoring technique.

20. A computer readable medium providing instructions for enabling determination of the quality of a service provided in a services registry, the instructions comprising instructions for:
providing a service-oriented architecture (SOA) repository that takes as input information from a plurality of data sources that map to a plurality of rating dimensions, the SOA repository including one or more services to be offered to a service consumer; and
providing a rating calculation engine that receives service characteristics for a service;
the rating calculation engine calculating, based on category weightings and rating rules that are customizable by an organization, a service quality rating that takes into account the plurality of rating dimensions; and
the rating calculation engine recalculating the service quality rating over time as the service is being used and goes through lifecycle stages.
